(19) United States
(12) Patent Application Publication
(10) Pub. No.: US 2003/0115367 A1
(43) Pub. Date: Jun. 19, 2003

(54) Address deducing system for deducing network settings

(75) Inventor: Kiyotaka Ohara, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/320,581

(22) Filed: Dec. 17, 2002

(30) Foreign Application Priority Data
Dec. 18, 2001 (JP) 2001-384700

(51) Int. Cl. G06F 15/16

(52) U.S. Cl. 709/249

(57) ABSTRACT

An address deducing system for deducing the IP address assigned to a gateway device from packets transmitted over a network, by identifying from the MAC address corresponding to an address list in which two or more types of IP addresses are entered the IP address assigned to the network device having this MAC address, and setting this IP address as the IP address assigned to the router. Next, if the number of address lists containing only one IP address exceeds a prescribed number, then a subnet mask is calculated based on the IP addresses entered in these address lists and the IP address of the router.

### BACKGROUND OF THE INVENTION

1. Field of the Invention

The present invention relates to an address deducing system used for deducing network settings.

2. Description of the Prior Art

Conventional network devices serving as components of a network do not initialize network settings themselves. Such initialization is performed through the input of such settings as a default gateway indicating the IP address of the gateway device (a router, for example), a subnet mask, an IP address assigned to the network device itself, and the like. Ordinarily a user inputs these settings through a control unit (an input panel or the like) provided on the network device. However, this inputting operation requires the input of numerous settings, including the default gateway, subnet mask, and IP address, resulting in a burden and inconvenience placed on the user.

In view of these problems, Japanese unexamined patent application publication No. 2000-194513 discloses a network device. This network device infers network settings from packets being transmitted over the network and presets these values as defaults in the prescribed input spaces during the initialization of the network settings. The network device then prompts the user whether to accept these settings.

This network device acquires a plurality of IP addresses by obtaining communication data on the network, then deduces a value for the network address through a method of setting each byte in the network address to values that are most commonly used for each byte of the IP address and are used at a percentage equal to or greater than a prescribed threshold. In IP addresses included in communication data transferred between network devices on the same network, the bits corresponding to the network address are always the same, regardless of the communication data. Further, since the host address is different for each network device, rarely is the same host address used at a percentage that exceeds a prescribed threshold value for all communication data. Consequently, it has been possible to use the above method for deriving the network address for a network to which the network device belongs. By learning the network address, it is possible to calculate a subnet mask by setting all bits other than those corresponding to the host address to “1”.

With this type of network device, it is possible to lighten the burden of operations placed on the user by not requiring the user to input a large number of settings.

However, one problem with this network device is that the device cannot deduce the IP address of a gateway device. Another problem is that the device cannot accurately deduce values of settings due to the following reasons.

For example, FIG. 1 shows networks Na and Nb, each including a plurality of network devices (hereinafter simply referred to as devices) connected to one another via a router A and a router B. When a device a1 in the network Na transmits a packet (a single block of data transmitted over a network) toward a device b1 in the network Nb with the above construction, the packet transmitted from the device a1 reaches the device b1 via the router A and router B. At this time, the source IP address of the packet transmitted to the device b1 from the router B is the IP address of the device a1. Since this IP address is an IP address within the network Na, the network address of the IP address differs from the network address of the network Nb. If a device b2 in the network Nb is monitoring packets being transmitted over the network Nb at this time and the number of packets transmitted from the network Na is larger than the number of packets transmitted and received between devices bn within the network Nb, then the device b2 might infer the network address of the network Na as the network address of the network Nb because most packets transmitting within the network Nb have the network address of the network Na.

### SUMMARY OF THE INVENTION

In view of the foregoing, it is an object of the present invention to provide an address deducing system and method, a network device, and a computer program for storing the address deducing method that are (1) capable of deducing the IP address assigned to a gateway device from packets being transmitted over a network and (2) capable of deducing values of network settings more accurately than conventional techniques.

According to one aspect of the invention, there is provided an address deducing system for deducing an IP address assigned to a gateway device that is one of a plurality of network devices on a network that performs communications between network devices using an Internet protocol and assigns different IP addresses to the plurality of network device. Each of the plurality of network devices has a personal MAC address. The address deducing system includes extracting means for extracting from data included in a packet transmitted over the network a destination MAC address and a destination IP address indicating the transmission destination of the packet; address deriving means for deriving from a MAC address an IP address assigned to a network device identified by the MAC address; and gateway address deducing means for deriving an IP address through the address deriving means for a MAC address paired with a plurality of IP addresses among a plurality of MAC addresses extracted by the extracting means, and deducing that the derived IP address is the IP address assigned to the gateway device.

The gateway device in the address deducing system is a router or other network device for relaying packets between networks. Further, the extracting means extracts a destination MAC address and destination IP address from data included in packets transmitted within the network.

The address deriving means is not limited to any particular construction, provided that the means is capable of deriving an IP address assigned to network devices identified by a MAC address. For example, when a network device functioning as a RARP (Reverse Address Resolution Protocol) server exists as a component of a network, the IP address assigned to a network device identified by a MAC address can be extracted using RARP. Another configuration for extracting an IP address can be implemented by preparing a data table correlating MAC addresses to IP addresses assigned to network devices identified by these MAC addresses in order to derive an IP address from the MAC address based on this data table.

The gateway address deducing means derives an IP address using the address deriving means for a MAC address extracted via the extracting means, and deduces that the derived IP address is the IP address assigned to the gateway device.

The gateway address deducing means in this address deducing system first derives an IP address using the address deriving means for a destination MAC address that is paired with a plurality of destination IP addresses from among a plurality of destination MAC addresses extracted by the extracting means. Here, the destination MAC address paired with a plurality of destination IP addresses is the address from among a plurality of destination MAC addresses extracted by the extracting means with which a plurality of destination IP addresses correspond. The derived IP address is deduced as that assigned to the gateway device.

Normally, the destination MAC address and destination IP address of a packet transmitted between network devices within the same network are both the address of the destination network device. Hence, packets transmitted between network devices within the same network are always formed of the same combination of destination MAC address and destination IP address. On the other hand, packets transmitted to another network via the gateway device include the IP address of the destination network device. However, since the destination MAC address must be first transmitted to the gateway device, this address is converted to the MAC address of the gateway device. In this way, the MAC address of packets transmitted to another network take on the MAC address of the gateway device, which is unrelated to the destination IP address. Hence, packets transmitted to another network via the gateway device do not always have the same combination of destination MAC address and destination IP address. Accordingly, it is possible to deduce that the destination MAC address having two or more types of IP addresses corresponding to the same destination MAC address is the MAC address for the gateway device. Therefore, an IP address derived by the address deriving means for the MAC address deduced in this way can be deduced to be the IP address of the gateway device.

An address deducing system having this construction can deduce the IP address of the gateway device from packets transmitted over a network.

The address deducing system as described above is also applicable to the case in which the extracting means extracts a source MAC address and source IP address from data included in packets transmitted over a network.

As with the address deriving means described above, this address deriving means derives an IP address assigned to the network device identified by a MAC address. Further, as with the gateway address deducing means described above, this gateway address deducing means deduces an IP address assigned to the gateway device.

The gateway address deducing means in this address deducing system first derives an IP address using the address deriving means for a source MAC address that is paired with a plurality of source IP addresses from among a plurality of source MAC addresses extracted by the extracting means. Here, the source MAC address paired with a plurality of source IP addresses is the address from among a plurality of source MAC addresses extracted by the extracting means with which a plurality of source IP addresses correspond. The derived IP address is deduced as that assigned to the gateway device.

Normally, the source MAC address and source IP address of a packet transmitted between network devices within the same network are both the address of the network device that originated the transmission. Hence, packets transmitted between network devices within the same network are always formed of the same combination of source MAC address and source IP address. On the other hand, packets transmitted from another network via the gateway device include the source IP address of the network device that originated the transmission. When the packet passes through the gateway device, however, the source MAC address is converted to the MAC address of the gateway device from that of the network device originating the transmission. In this way, the MAC address of packets transmitted from the other network take on the MAC address of the gateway device, which is unrelated to the source IP address. Hence, packets transmitted from the other network via the gateway device do not always have the same combination of source MAC address and source IP address. Accordingly, it is possible to deduce that the source MAC address with which two or more IP addresses correspond is the MAC address of the gateway device. In this process, therefore, an IP address derived from this deduced MAC address by the address deriving means can be deduced to be the IP address of the gateway device.

An address deducing system having this construction can deduce the IP address of the gateway device from packets transmitted over a network.

In the address deducing systems described above, a MAC address paired with a plurality of IP addresses is used as the object for deriving an IP address via the address deriving means. It is also possible to use the MAC address that is paired to the most number of IP addresses as the object for deriving the IP address via the address deriving means. This MAC address is the address having the most corresponding IP addresses from among the plurality of MAC addresses extracted by the extracting means.

The address deducing system as described above may further include address list creating means for creating an address list for each different MAC address in which address list one or more IP addresses corresponding to the MAC address are entered and for recording IP addresses paired with the MAC address in the address list corresponding to the MAC address when a pair of a MAC address and IP address extracted by the extracting means has not been extracted in the past, wherein the gateway address deducing means determines a MAC address with which a plurality of IP addresses is paired based on an address list created by the address list creating means, derives an IP address for the determined MAC address with the address list deriving means, and deduces that the derived IP address is the IP address assigned to the gateway device.

The address list in this address deducing system records a correspondence of one or more IP addresses to a MAC address. Further, the address list creating means records an extracted IP address in an address list corresponding to the extracted MAC address when the pair of the MAC address and IP address extracted by the extracting means has not been extracted before.

In the address deducing system, the gateway address deducing means first determines the MAC address paired with a plurality of IP addresses based on the address lists created by the address list creating means. Here, the MAC address paired with a plurality of IP addresses is a MAC address corresponding to an address list from among a plurality of address lists in which a plurality of IP address types have been entered. An IP address is derived for the determined MAC address using the address deriving means and the derived IP address is deduced to be the IP address assigned to the gateway device.

In an address deducing system having this constructions when a pair of a MAC address and an IP address extracted by the extracting means has not been extracted before, the extracted IP address is recorded in the address list corresponding to the extracted MAC address. In this way, it is possible to determine the MAC address paired with a plurality of IP addresses based on the number of IP addresses entered in each address list.

In the address deducing system described above, the MAC address paired with a plurality of IP addresses is used as the object for deriving an IP address using the address deriving means. It is also possible to use the MAC address that is paired to the most number of IP addresses as the object for deriving the IP address via the address deriving means. This MAC address is the address corresponding to the address list, from among the plurality of address lists, in which the most number of IP addresses is entered.

The address deducing system may further include subnet mask calculating means for identifying a MAC address paired with only a single IP address from among a plurality of MAC addresses extracted by the extracting means, and calculating a subnet mask based on the IP address paired with the identified MAC address and the IP address of the gateway device deduced by the gateway address deducing means.

The subnet mask calculating means of the address deducing system described above calculates a subnet mask based on a MAC address paired with only a single IP address and the IP address of the gateway device deduced by the gateway address deducing means. Here, the MAC address paired with only one IP address is a MAC address from the plurality of MAC addresses extracted by the extracting means having only one corresponding IP address. This type of MAC address has only one corresponding IP address, despite the fact that a plurality of MAC addresses are extracted by the extracting means, indicating that the MAC address is extracted from a packet always having then same combination of MAC address and IP address, that is, a MAC address extracting from a packet transmitted between network devices within the same network.

The subnet mask calculating means in this address deducing system is not limited to a particular construction for calculating the subnet mask. For example, the subnet mask calculating means may calculate the subnet mask according to the following steps. The subscript of the IP addresses Cn described below indicate the sequential order of the plurality of IP addresses. Further, the subscript of each value (from D to F) indicates the number of passes through steps 1-4 in which the value was calculated. The value A0 indicates the value A when all bits have been initialized to “1”.

In the first step of the process, a value D is calculated by performing an exclusive OR operation on the IP address B and the IP address Cn, wherein corresponding bits in each address that do not match are set to “1” (Dn=(B)XOR (Cn)). In step 2, a value E is calculated in which matching bits are set to “1” for each bit in the IP addresses B and Cn by performing a NOT operation on the value D calculated in step 1 (En=NOT (Dn)).

The IP address Cn corresponds to the MAC addresses with only one corresponding IP address. This type of IP address is extracted from packets transmitted between network devices within the same network. On the other hand, the IP address B is the address for the gateway device. Based on this information, the IP addresses Cn and B are addresses used within the same network. Accordingly, at least bits making up the IP address B and IP address Cn that correspond to the network address should be the same value. Accordingly, the value En calculated in step 2 will have a “1” for at least bits corresponding to the network address in the IP addresses B and Cn. However, at this stage, it is possible that some bits corresponding to the host address also match. For this reason, the following process is performed to set bits corresponding to the host address to “0”.

In step 3, a value F is calculated in which bits are set to “1” when each corresponding bit in the value En and An−1 are both “1” by performing a logical AND on the value E calculated in step 2 and the value An−1 (Fn=(En) AND (An−1)).

In step 4, the value An is reset to the value Fn calculated in step 3 (An Fn). The value set in An at this time is a candidate for the subnet mask. In step 5, the processes of steps 1-4 are repeated according to the number of Cn, wherein the last value set to An in step 4 is set as the subnet mask. In step 5, steps 1-4 are repeated sequentially for IP addresses C1-Cn.

While the network addresses in the IP addresses C1 through Cn are the same, their host addresses are different. For this reason, the final value A calculated in step 5 will have a “0” set for each bit corresponding to the host address by repeatedly performing steps 1-4 sequentially on IP addresses C1 through Cn. Hence, only bits in the value An corresponding to the network address will be set to “1,” thereby forming the subnet mask.

In a address deducing system with this construction, the subnet mask calculating means can calculate a subnet mask using the IP address Cn extracted from packets transmitted between network device within the same network. Accordingly, the present invention can deduce a subnet mask serving as network settings more accurately than the conventional method, even when the number of packets transferred to or from another network is larger than the number of packets transferred between network devices within the same network.

As another configuration of the subnet mask calculating means for calculating a subnet mask, it may calculate a subnet mask based on the highest-order byte in the IP address of the gateway device deduced by the gateway address deducing means.

IP addresses are divided into a plurality of classes, wherein the subnet mask of each IP address is determined based on the range of numbers that can be used in each class. For example, the numbers that can be used in the highest-order byte of a class A range from “1” to “107” (decimal) and the subnet mask is “255.0.0.0”. The numbers that can be used in the highest-order byte of a class B range from “128” to “191” and the subnet mask is “255.255.0.0”. The numbers that can be used in the highest-order byte of a class C range from “192” to “223” and the subnet mask is “255.255.255.00”.

Based on this information, the subnet mask calculating means calculates the subnet mask based on the range of usable numbers and the subnet mask determined by the classes described above. For example, if the highest-order byte in the IP address is a value between “1” and “127,” then the subnet mask is “255.0.0”. If a highest-order byte is between the values “128” and “191,” then the subnet mask is “255.255.0.0”. If a highest-order byte is a value between “192” and “223,” then the subnet mask is “255.255.255.0”.

With an address deducing system of this construction, the subnet mask calculating means can calculate a subnet mask from the IP address of the gateway device.

Network address calculating means may calculate a network address based on the IP address of the gateway device deduced by the gateway address deducing means and the subnet mask calculated by the subnet mask calculating means.

In such a case, the network address deriving means in the address deducing system derives a network address by performing a logical AND operation on the IP address of the gateway device and the subnet mask.

According to another aspect of the invention, there is provided a network device having the address deducing system as described above and requiring as one of network settings at least the IP address of a gateway device on a network to which the network device belongs. The network device includes display means for displaying the IP address of the gateway device deduced by the gateway address deducing means.

In a network device of this construction, the gateway address deducing system can display the calculated IP address of the gateway device on the display means. Particularly, when the user performs input operations to set the IP address of the gateway device, the network device can be configured to display the IP address of the gateway device, enabling the user to perform input operations while viewing the displayed IP address. In this way, it is possible to prevent the user from inputting an incorrect IP address.

Further, the network device displays input spaces for inputting IP addresses on the display means. The network device can be configured to enter the IP address of the gateway device in the space for the IP address. If the values are preset in the input spaces displayed on the display means when the user is inputting IP addresses, the user's burden can be reduced.

### BRIEF DESCRIPTION OF THE DRAWINGS

The particular features and advantages of the invention as well as other objects will become apparent from the following description taken in connection with the accompanying drawings, in which;

FIG. 1 is an explanatory diagram showing the general construction of a conventional network;

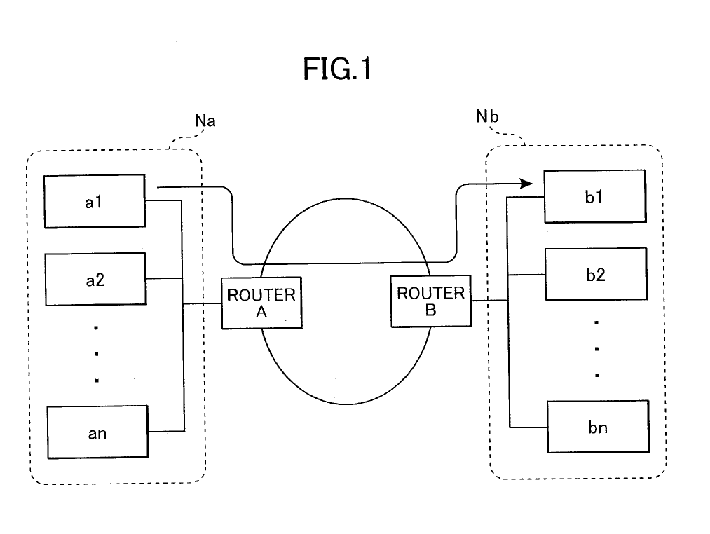

FIG. 2 is an explanatory diagram showing a network comprising a network printer;

FIG. 3 is a flowchart illustrating a network setting process according to a first embodiment;

FIG. 4 is an explanatory diagram showing a settings window displayed on a display device;

FIG. 5 is a flowchart illustrating a process for creating an address list according to the first embodiment;

FIG. 6 is an explanatory diagram showing the data structure of address lists;

FIG. 7 is a flowchart illustrating a process for calculating a subnet mask according to the first embodiment;

FIG. 8 is a flowchart illustrating a network setting process according to a second embodiment; and

FIG. 9 is a flowchart illustrating a process for calculating a subnet mask according to the second embodiment.

### DETAILED DESCRIPTION OF THE PREFERRED EMBODIMENT

Next, preferred embodiments of the present invention will be described while referring to the accompanying drawings.

First Embodiment

Overall Construction

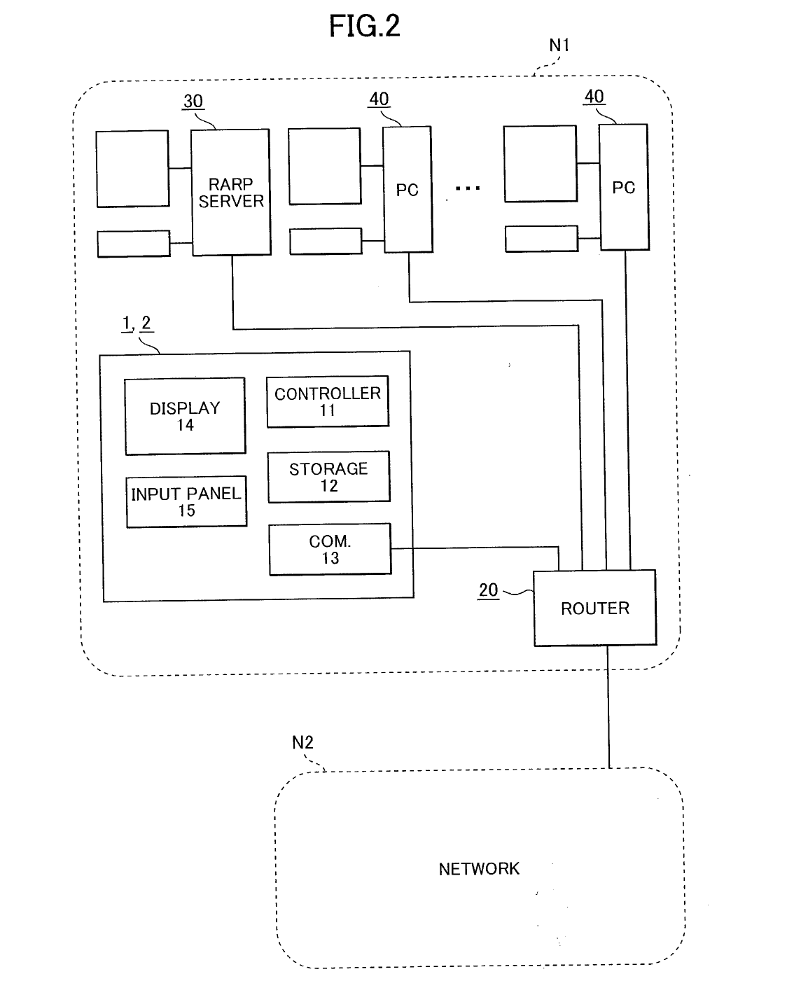

As shown in FIG. 2, a network printer 1 (hereinafter simply referred to as “printer”) is a network device serving as a component of a network N1, along with other network devices, including a router 20, a computer system 30 functioning as an RARP (Reverse Address Resolution Protocol) server 30 (hereinafter simply referred to as RARP server), a plurality of personal computers 40, and the like. The network N1 is connected to a network N2 via the router 20.

The printer 1 comprises a controller 11, a storage device 12, a communication device 13, a display device 14, an input panel 15, and the like. The printer 1 incorporates an application program capable of using RARP to identify from a MAC address the IP address assigned to a network device having this MAC address. Using the functions of this application program, the printer 1 transmits a RARP request along with the MAC address to the RARP server 30. Upon receiving this RARP request, the RARP server 30 identifies the IP address of the network device possessing this MAC address based on the MAC address included in the RARP request and returns a RARP response containing this identified IP address to the printer 1. In this way, the printer 1 can identify from the MAC address the IP address assigned to the network device possessing this MAC address. Here, the printer 1 functions as the address deriving device of the present invention.

The printer 1 is a network device having the address deducing system of the present invention.

Network Setting Process

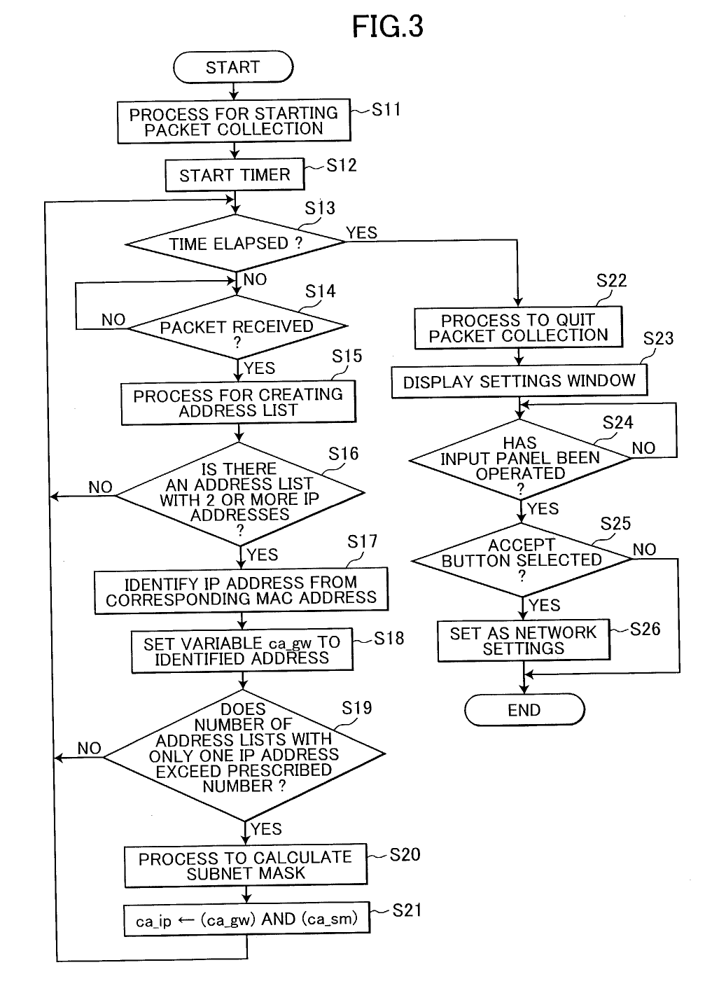

First a network setting process executed by the controller 11 provided in the printer 1 will be described based on the flowchart in FIG. 3. This network setting process begins after an operation is executed through the input panel 15 indicating a desire to begin the network setting process.

In S11, the controller 11 performs a process to begin collecting packets. In this process, the printer 1 switches from a normal state of receiving only packets addressed to the printer 1 (including broadcast and multicast transmissions) to a packet collection mode for receiving all packets including those addressed to the printer 1.

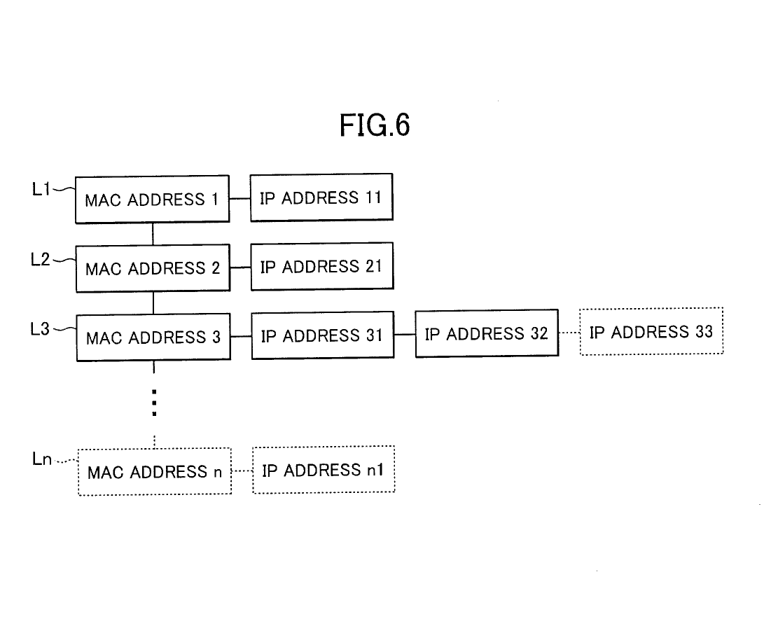

In S12, the controller 11 starts a timer. In S13, the controller 11 checks whether the timer has reached the preset time (30 seconds in the present embodiment). While the timer has not reached the preset time in the process of S13 (No in S13), the controller 11 waits until a packet is received (No in S14). When the controller 11 receives a packet (Yes in S14), then the controller 11 performs a process to create an address list in S15. This process creates a list of addresses in which one or more types of IP addresses are entered for the MAC address based on the source IP address and source MAC address for the packet received in S14. To begin this process, an address list is created corresponding to the source MAC address for the packet in received in S14, if one does not already exist. Next, the source IP address of this packet is entered in the address list corresponding to the source MAC address of the packet (See FIG. 6). The steps of this process will be described in more detail in the process for creating an address list described later.

In S16, the controller 11 checks whether there exists an address list among the address lists created in the process of S15 in which two or more types of IP addresses are entered. In the process of S16, if an address list in which two or more types of IP addresses are entered exists (Yes in S16), then the controller 11 identifies in S17 from a MAC address corresponding to the address list in which two or more types of IP addresses are entered the IP address assigned to the network device having this MAC address.

Normally, the source MAC address and source IP address of a packet transmitted between network devices in the network N1 are both the address of the network device that originated the transmission. Hence, packets transmitted between network devices in the network N1 are always formed of the same combination of source MAC address and source IP address. On the other hand, packets transmitted from another network N2 via the router 20 include the source IP address of the network device that originated the transmission. When the packet passes through the router 20, however, the source MAC address is converted to the MAC address of the router 20 from that of the network device originating the transmission. In this way, the MAC address of packets transmitted from the other network N2 take on the MAC address of the router 20, which is unrelated to the source IP address. Hence, packets transmitted from the other network N2 via the router 20 do not always have the same combination of source MAC address and source IP address. Accordingly, it is possible to deduce that the source MAC address corresponding to an address list in which two or more types of IP addresses are entered is the MAC address for the router 20. In this process, therefore, an IP address identified from a MAC address corresponding to an address list in which two or more types of IP addresses are entered can be deduced to be the IP address of the router 20.

In S18, the controller 11 sets the IP address identified in S17 to the variable ca_gw as the IP address assigned to the router 20. This variable ca_gw comprises the same number of bits as the IP address. In S19, the controller 11 checks whether the number of address lists in which only one type of IP address is entered among those created in S15 exceeds a prescribed number (three in the present embodiment). Here, an address list including only one IP address has only one type of IP address despite a plurality of address lists being created by repeatedly performing the address list creation process, indicating an address list created based on a packet always having the same combination of MAC address and IP address corresponding to the address list, that is, a packet transmitted between network devices in the network N1.

If the number of address lists in which only one type of IP address is entered exceeds the prescribed number in S19 (Yes in S19), then the controller 11 performs a subnet mask calculating process in S20. This process calculates a subnet mask based on the IP address entered in the address list in which only one type of IP address is entered and the variable ca_gw set to the IP address of the router 20, and sets a variable ca_sm to this calculated subnet mask. This variable variable ca_sm is configured of the same number of bits as the IP address. The steps for this process will be described in more detail later in the process for calculating the subnet mask.

In S21, the controller 11 calculates the network address and sets a variable ca_ip to the calculated address. In this process, the network address is calculated by taking the logical AND of the variable ca_qw set as the IP address assigned to the router 20 and the variable ca_sm set as the subnet mask, and then setting the variable ca_ip to the calculated network address (ca_ip (ca_gw) AND (ca_sm)). This variable ca_ip is configured of the same number of bits as the IP address.

The process returns to S13 after performing the process in S21, or when the number of address lists in which only a single type of IP address is entered is less than the prescribed number (No in S19), or when an address list exists in which two or more types of IP addresses are entered (No in S16).

When the timer reaches the preset time while repeating the processes from S13 to S21 (Yes in S13), then the controller 11 executes the process for ending packet collection in S22. Through this process, the printer 1 shifts from the packet collection mode to the normal mode.

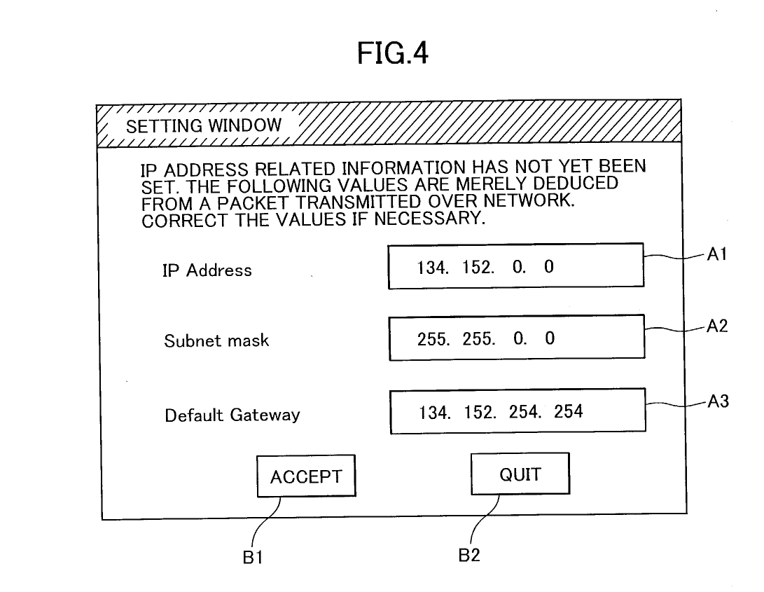

In S23, the controller 11 displays a settings window on the display device 14. As shown in FIG. 4, this process displays a settings window having input spaces (A1 through A3 in FIG. 4) for setting the IP address assigned to the printer 1, the subnet mask, and the default gateway, which is the IP address of the router 20; an accept button B1 for accepting the values inputted in each input space as network settings for the printer 1; a quit button B2 for ending the network setting process; and the like. Here, values are inputted in advance into the input spaces in the settings window, including decimal values representing each 8 bits of the variable ca_ip inputted in the “IP address” input space A1, decimal values representing each 8 bits of the variable ca_sm in the “subnet mask” input space A2, and decimal values representing each 8 bits of the variable ca_gw inputted in the “default gateway” input space A3. After the settings window is displayed in the display device 14, the user can operate the input panel 15 to modify values inputted in each input space, select the accept button B1, and select the quit button B2. Further, since the value inputted in the “IP address” input space A1 is a network address, the user can only change this to a value corresponding to a host address.

Next, the controller 11 waits until the input panel 15 is operated (No in S24). In this process, the controller 11 waits until either an operation selecting the accept button B1 or an operation selecting the quit button B2 is executed. When the input panel 15 is operated in the process of S24 (Yes in S24), and when the operation is an operation for selecting the accept button B1 (Yes in S25), then in 526 the values inputted into the input spaces in the settings window are set as the network settings of the printer 1.

After completing the process of S26, or when the operation performed in the process of S24 is an operation to select the quit button B2 (No in S25), then the network setting process ends. If the operation for selecting the quit button B2 was selected at this time, then the network setting operation ends without modifying the network settings.

In steps S13-S18 of the network setting process described above, the controller 11 functions as the gateway address deducing device of the present invention by setting the variable ca_gw to the IP address identified in S17 as the IP address assigned to the router 20.

In steps S20 and S21, the controller 11 functions as the network address deducing device of the present invention by calculating the network address and setting the variable ca_ip to this address. In step S23, the display device 14 used to display the settings window functions as the display device of the present invention.

In step S17 of this network setting process, the controller 11 is configured to identify from a MAC address corresponding to the address list in which two or more IP address are entered the IP address assigned to the network device having this MAC address. However, it is also possible to configure the controller 11 to identify the IP address in S17 from the MAC address corresponding to an address list having the highest number of recorded IP addresses.

Process for Creating an Address List

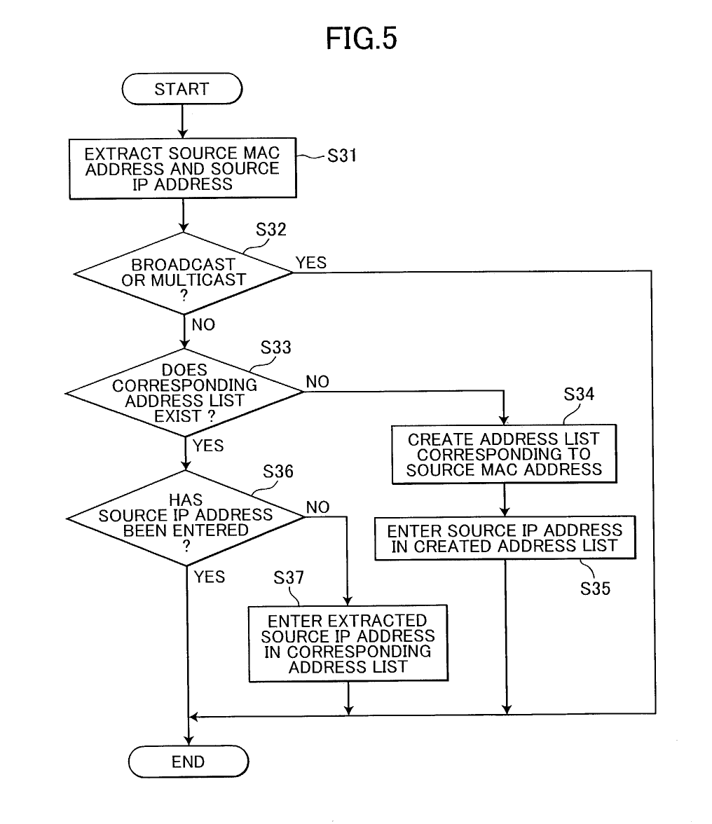

Next, the process for creating an address list executed by the controller 11 in the printer 1 will be described with reference to FIG. 5. This address list creation process illustrates more detailed steps for the process of S15 in FIG. 3.

First, the controller 11 extracts the source MAC address and source IP address of the packet in S31 from the packet received in the process of S14 of FIG. 3. In S32, the controller 11 checks whether the destination MAC address of the packet received in S14 (or the destination IP address) is a broadcast address or multicast address.

If the destination MAC address (or destination IP address) is not a broadcast or multicast address (No in S32), then the controller 11 checks in S33 whether there exists an address list corresponding to the source MAC address extracted in step S31.

If an address list corresponding to the source MAC address does not exist (No in S33), then the controller 11 creates in S34 an address list corresponding to the source MAC address extracted in S31. In this process, an address list Ln corresponding to the source MAC address is appended to the end of the already existing address lists, as shown in FIG. 6.

In S35, the controller 11 records the source IP address extracted in S31 in the address list created in S34. In this process, the source IP address n1 is entered in the address list Ln created in S34.

However, if an address list corresponding to the source MAC address already exists (Yes in S33), then in S36 the controller 11 checks whether the source IP address extracted in S31 is already entered in the address list corresponding to the source MAC address.

When the source IP address is not entered in the address list (No in S36), then in S37 the controller 11 enters the source IP address extracted in S31 in the address list corresponding to the source MAC address. In this process, a source IP address 33 extracted in S31 is entered at the end of an address list L3 corresponding to the source MAC address, for example.

The present address list creation process ends after completing the process in S37, when the source IP address is entered in S36 (Yes in S36), after completing the process of S35, or when the destination MAC address (or destination IP address) is either a broadcast address or a multicast address (Yes in S32).

In step S31 of the address list creation process, the controller 11 functions as an extracting device in the present invention for extracting the source MAC address and source IP address from the packet. In steps S33 and S37, the controller 11 functions as the address list creating device of the present invention for entering the source IP address in the address list corresponding to the source MAC address.

Process for Calculating a Subnet Mask

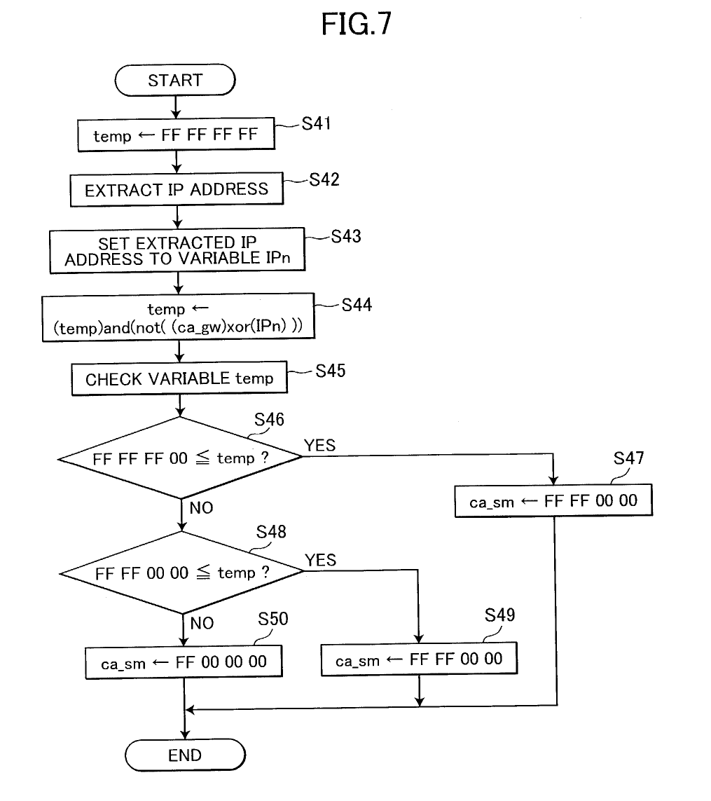

Next, the process for calculating the subnet mask executed by the controller 11 will be described with reference to FIG. 7. This subnet mask shows more detailed steps of the process in S20 of FIG. 3.

In S41, the controller 11 initializes a variable temp. In this process, all bits in the variable temp are set to “1” (“FF FF FF FF” in hexadecimal). The variable temp comprises the same number of bits as the IP address. In S42, the controller 11 extracts an IP address from all address lists in which only one IP address is entered from a plurality of address lists created in the address list creation process of FIG. 5.

In S43, the controller 11 sets a variable IPn (IP1-IPn) to the IP address extracted in S42. This variable IPn comprises the same number of bits as the IP address. In S44, the controller 11 repeatedly performs a logical AND (temp (temp) AND (not ((ca_gw) xor (IPn)))) based on the variables temp, IPn, and ca_gw sequentially from the variable IP1 to the variable IPn.

In the first step of this process, an exclusive OR operation is performed on the variables ca_gw and IPn ((ca_gw) XOR (IPn)), thereby calculating values of “1” only for bits in each variable that do not match. In the second step of the process, a NOT operation is performed on the values calculated in the first step (NOT ((ca_gw) XOR (IPn) )), thereby calculating a value of “1” only for bits that match among bits in the variables ca_gw and IPn.

The variables IPn are set to IP addresses entered in address lists in which only one type of IP address is entered. This type of IP address is extracted from a packet that always has the same combination of IP address and MAC address corresponding to the address list in which the IP address is entered, that is, a packet transmitted between network devices within the network N1. On the other hand, the variable ca_gw is the IP address of the router 20. Based on this information, the variable ca_gw and the variables IPn are each set to IP addresses used within the network N1. Accordingly, at least the bits corresponding to the network address in the variables ca_gw and IPn should be set to the same values. Hence, the values for (NOT ((ca_gw) XOR (IPn) )) calculated in the second step of the process will result in values of “1” for at least all bits corresponding to the network address in the variables ca_gw and IPn. However, it is possible at this stage for some bits corresponding to the host address in the variables to match, as well. As a result, the following third step is performed to set bits corresponding to the host address to “0”.

By performing a logical AND operation on values calculated in step 2 and the variable temp ((temp) AND (NOT ((ca_gw) XOR (IPn) )), bits set to “1” in both variables are calculated as a “1” value.

As a fourth step, the variable temp is reset to the value calculated in the third step (temp (temp) AND (NOT ((ca_gw) XOR (IPn)))). Here, the value set in the variable temp becomes a candidate for the subnet mask. In the fifth step, steps 1-4 are repeated for the number of variables IPn and the final value set as the variable temp in step 4 is set as the subnet mask. In step 5, steps 1-4 are repeated sequentially from variable IP1 to variable IPn.

While the network addresses in the variables IP1 through IPn are the same, their host addresses are different. For this reason, the final variable temp calculated in step 5 will have a “0” set for each bit corresponding to the host address by repeatedly performing steps 1-4 sequentially on variables IP1 through IPn. Hence, only bits in the variable temp corresponding to the network address will be set to “1”, thereby forming the subnet mask.

In S45, the controller 11 checks the value set in the variable temp. If the value set to the variable temp found in S45 is greater than or equal to the hexadecimal value “FF FF FF 00” (Yes In S46). then in S47 the variable ca_sm is set to “FF FF FF 00”.

If the value set to the variable temp found in S45 is greater than or equal to the hexadecimal value “FF FF 00 00” (No in S46 and Yes in S48), then in S49 the variable ca_sm is set to “FF FF 00 00”. If the value set to the variable temp is less than the hexadecimal value “FF FF 00 00” (No in S46 and No in S48), then the variable ca_sm is set to “FF 00 00 00” in S50.

In the subnet mask calculating process described above, the controller 11 functions as the subnet mask calculating device of the present invention by performing processes S41 through S50.

Effects of the First Embodiment

With the printer 1 configured as described above, it is possible to deduce the IP address of the router 20 from packets transmitted over the network.

In the process of S21 shown in FIG. 3, it is possible to calculate the network address from the variable ca_gw set to the IP address assigned to the router 20 and the variable ca_sm set to the subnet mask. In S23, the present invention can display the estimated IP address of the router 20, the subnet mask, and the network address on the display device 14. When performing network settings for the printer 1, the estimated IP address for the router 20, subnet mask, and network address are inputted in the input spaces in advance (A1-A3 in FIG. 4). Accordingly, the user can input only the value corresponding to the host address among the values inputted in the “IF address” input space, thereby reducing the burden of operations placed on the user.

If the pair of source MAC address and source IP address extracted in the process of S31 in FIG. 5 has not been extracted in the past, then the extracted source IP address is entered into the address list corresponding to the source MAC address. Hence, in the process of S17 in FIG. 3, it is possible to identify a MAC address corresponding to an address list in which a plurality of IP addresses is entered as the MAC address of the router 20. Further, in the process of S42 shown in FIG. 7, an IP address entered in the address list having only one IP address can be extracted as the IP address of a packet transmitted between network devices within the network N1.

In the processes of S41 through S50 in FIG. 7, a subnet mask can be calculated using the variables IPn set to IP addresses extracted from packets transmitted between network devices within the network N1. Accordingly, the present invention can deduce a subnet mask serving as network settings more accurately than the conventional method, even when the number of packets transferred from another network N2 is larger than the number of packets transferred between network devices within the network N1.

Second Embodiment

A network printer 2 (hereinafter simply referred to as “printer”) has the same configuration as the printer 1 in the first embodiment. The steps of the processes executed by the controller 11 vary in part, and only these differences will be described in detail.

Network Setting Process

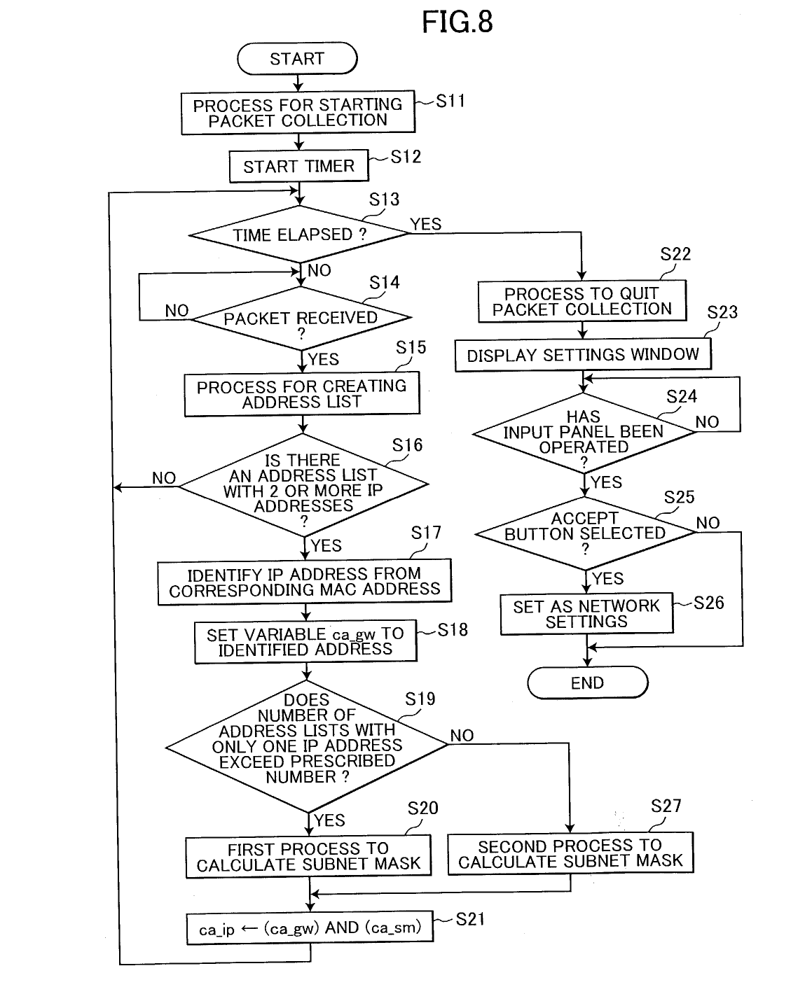

First the network setting process executed by the controller 11 in the printer 2 will be described with reference to FIG. 8. Here, only parts of this process that differ with the network setting process in FIG. 3 according to the first embodiment will be described.

In S11, the controller 11 performs a process to begin packet collection. In S12, the controller 11 starts a timer. In S13, the controller 11 checks whether the timer has reached a preset time. While the timer has not reached the preset time in the process of S13 (No in S13), the controller 11 waits until a packet is received (No in S14). When the controller 11 receives a packet (Yes in S14), then the controller 11 performs a process to create an address list in S15.

In S16, the controller 11 checks whether there exists an address list in the address list from among those created in the process of S15 in which two or more types of IP addresses are entered. In the process of S16, if an address list in which two or more types of IF addresses are entered exists (Yes in S16), then the controller 11 identifies in S17 from the MAC address corresponding to the address list in which two or more types of IP addresses are entered the IP address assigned to the network device having this MAC address.

In S18, the controller 11 sets the variable ca_gw to the IP address identified in S17 as the IP address assigned to the router 20. In S19, the controller 11 checks whether the number of address lists in which only one type of IP address is entered among those created in S15 exceeds a prescribed number.

If the number of address lists in which only one type of IP address is entered is greater than or equal to the prescribed number in S19 (Yes in S19), then the controller 11 performs a first subnet mask calculating process in S20. This process is the same as the subnet mask calculating process of S20 in FIG. 3 of the first embodiment.

However, if the number of address lists in which only a single type of IP address is entered is less than the prescribed number (No in S19), then in S27 the controller 11 performs a second subnet mask calculating process. This process calculates a subnet mask based on the variable ca_gw set to the IP address of the router 20 and sets the variable ca_sm to the calculated subnet mask. The steps of this process are described below in more detail in the second subnet mask calculating process executed by the controller 11.

In S21, the controller 11 calculates the network address and sets a variable ca_ip to the calculated address (ca_ip (ca_gw) AND (ca_sm)). After completing the process in S21 or when an address list exists in which two or more types of IP addresses are entered (No in S16), then the process returns to S13.

When the timer reaches the preset time while repeating the processes from S13 to S21 (Yes in S13), then the controller 11 executes the process for ending packet collection in S22. In S23, the controller 11 displays a settings window on the display device 14.

Next, the controller 11 waits until the input panel 15 is operated (No in S24).When the input panel 15 is operated in the process of S24 (Yes in S24), and when the operation is an operation for selecting the accept button B1 (Yes in S25), then in S26 the values inputted into the input spaces in the settings window are set as the network settings of the printer 1.

After completing the process of S26, or when the operation performed in the process of S24 is an operation to select the quit button B2 (No in S25), then the network setting process ends.

Second Subnet Mask Calculating Process

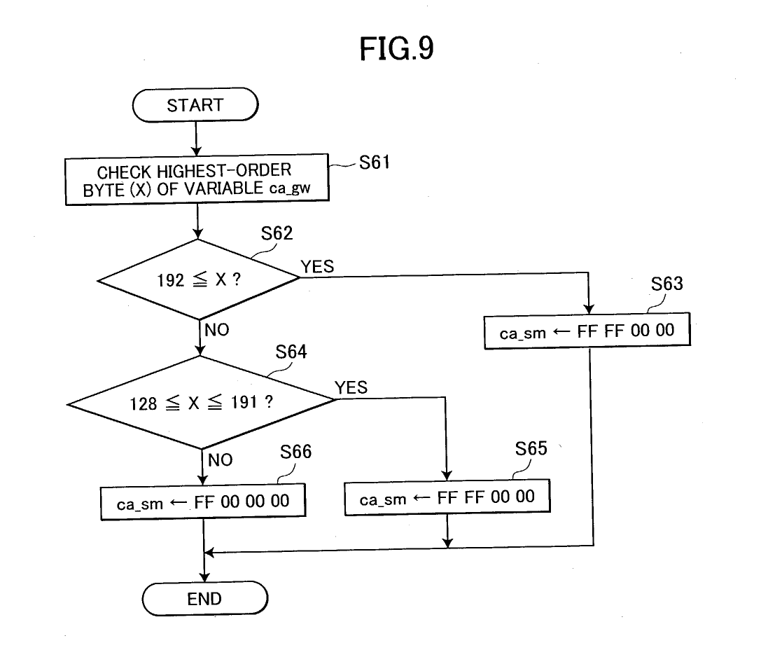

Next, a subnet mask calculating process executed by the controller 11 of the printer 2 in S27 will be described with reference to FIG. 9.

In S61, the controller 11 checks the highest-order byte of the variable ca_gw. If the value of the high-order 8 bits in the variable ca_gw found in S61 is greater than or equal to the decimal value 192 (Yes in S62), then the variable ca_sm is set to the hexadecimal value “FF FF FF 00” in S63.

If the value of high-order 8 bits in the variable ca_gw found in S61 is greater than or equal to the decimal value 128 and less than or equal to the decimal value 191 (No in S62 and Yes in S64), then in S65 the variable ca_sm is set to the hexadecimal value “FF FF 00 00”. If the high-order 8 bits in the variable ca_gw is less than the decimal value 128 (No in S62 and No in S64), then in S65 the variable ca_sm is set to the hexadecimal value “FF 00 00”.

In S61 through S66 of the subnet mask calculating process, the controller 11 functions as the subnet mask calculating device of the present invention by setting the variable ca_sm to a prescribed value.

Effects of the Second Embodiment

The printer 2 configured as described above can achieve the same effects as the printer 1 described in the first embodiment. Further, the printer 2 can calculate the subnet mask from the IP address of the router 20 in steps S61 through S66 of FIG. 9.

Variations of the Embodiments

While the invention has been described in detail with reference to specific embodiments thereof, it would be apparent to those skilled in the art that many modifications and variations may be made therein without departing from the spirit of the invention, the scope of which is defined by the attached claims. For example, the present invention has been applied to printers 1 and 2 in the embodiments described above, but the present invention can be applied to other network devices, as well.

In the embodiments described above, the printer is configured to input in advance, decimal values representing each 8 bits of the variable ca_ip in the “IP address” input space of the settings window in step S23 of FIG. 3. At this time, the printer can be configured to prompt the user to input values corresponding to the host address by displaying the portion corresponding to the host address in the pre-input value to a different color from the other part. Another possibility is to input in the “IP address” input space in advance decimal values for each 8 bits representing only bits corresponding to the network address in the variable ca_ip, while inputting a symbol, such as “*” in the input areas corresponding to the host address and prompting the user to input values corresponding to the host address.

In the embodiment described above, parameters are inputted in each input space in the settings window in step S23 of FIG. 3, including the estimated IP address of the router 20, subnet mask, and network address. However, these parameters can be displayed in an area outside of these input spaces.

In the embodiments described above, the estimated network address is displayed in the “default gateway” input space A3 of the settings window in step S23 of FIG. 3. However, it is also possible to display the IP addresses extracted in S42 from all address lists having only one address of FIG. 7 in an area outside the input spaces as Ip addresses used on the network N1. In this case, when the user executes an operation to input an IP address in the “IP address” input space A1, the user can set the IP address for the printer 1 to a value other than the displayed IP addresses without mistakenly setting the IP address to one already being used on the network N1.

In the embodiments described above, the printer is configured to extract the source MAC address and source IP address from packets in the process of S31 in FIG. 5. However, the printer can instead extract the destination MAC address and destination IP address from the packet in the same process. With this configuration, it is possible to achieve the same operations and effects as the embodiments described above.

In S42 of FIG. 7, it is also possible to set the IP addresses extracted from all address lists having only one IP address as IP addresses that are used on the network N1 and to display IP addresses that can be used on the network N1, excluding these IP addresses, in an area outside of the input spaces. In this case, when inputting an IP address in the “IP address” input space A1. the user can set the IP address of the printer 1 to one of the displayed IP addresses without accidentally setting the IP address of the printer 1 to an address currently being used on the network N1.

In the embodiments described above, step S13 of FIGS. 3 and 8 manage the interval for performing packet collection by a timer. However, this process can be configured to end at the time all packets necessary for performing the network setting process are collected.

What is claimed is:

1. An address deducing system for deducing an IP address assigned to a gateway device that is one of a plurality of network devices on a network that performs communications between network devices using an Internet protocol and assigns different IP addresses to the plurality of network devices, each of the plurality of network devices having a personal MAC address, the address deducing system comprising:
extracting means for extracting from data included in a packet transmitted over the network a destination MAC address and a destination IP address indicating the transmission destination of the packet;
address deriving means for deriving from a MAC address an IP address assigned to a network device identified by the MAC address; and
gateway address deducing means for deriving an IP address through the address deriving means for a MAC address paired with a plurality of IF addresses among a plurality of MAC addresses extracted by the extracting means, and deducing that the derived IP address is the IP address assigned to the gateway device.

2. The address deducing system as recited in claim 1, further comprising address list creating means for creating an address list for each different MAC address in which address list one or more IP addresses corresponding to the MAC address are entered and for recording IP addresses paired with the MAC address In the address list corresponding to the MAC address when a pair of a MAC address and IP address extracted by the extracting means has not been extracted in the past,
wherein the gateway address deducing means determines a MAC address with which a plurality of IP addresses is paired based on an address list created by the address list creating means, derives an IP address for the determined MAC address with the address list deriving means, and deduces that the derived IP address is the IP address assigned to the gateway device.

3. The address deducing system was recited in claim 1, further comprising subnet mask calculating means for identifying a MAC address paired with only a single IP address from among a plurality of MAC addresses extracted by the extracting means, and calculating a subnet mask based on the IP address paired with the identified MAC address and the IP address of the gateway device deduced by the gateway address deducing means.

4. The address deducing means as recited in claim 3, wherein the subnet mask calculating means uses a value A having the same number of bits as an IP address and an initial value of “1” for each bit, an IP address B for the gateway device deduced by the gateway address deducing means, and one or more IP addresses Cn paired with one or more MAC addresses identified a plurality of MAC addresses extracted by the extracting means to be paired with a single IP address; and executes a step 1 for calculating a value D by performing an exclusive OR operation on the IP address 9 and the IP addresses Cn, a step 2 for calculating a value E by performing a NOT operation on the value D calculated in step 1, a step 3 for calculating a value F by performing a logical AND operation on the value E calculated in step 2 and the value A, a step 4 for resetting the value A to the value F calculated in step 3, and a step 5 for repeating the steps 1 through 4 based on the number of IF addresses Cn; and setting the subnet mask to the final value of the value A set in step 4.

5. The address deducing system as recited in claim 1, further comprising subnet mask calculating means for calculating a subnet mask based on the highest-order byte in the IP address of the gateway device deduced by the gateway address deducing means.

6. The address deducing system as recited in claim 3, further comprising network address calculating means for calculating a network address based on the IP address of the gateway device deduced by the gateway address deducing means and the subnet mask calculated by the subnet mask calculating means.

7. An address deducing system for deducing an IP address assigned to a gateway device that is one of a plurality of network devices on a network that performs communications between network devices using an Internet protocol and assigns different IP addresses to the plurality of network devices, each of the plurality of network devices having a personal MAC address, the address deducing system comprising:
extracting means for extracting from data included in a packet transmitted over the network a source MAC address and a source IP address indicating the transmission source of the packet;
address deriving-means for deriving from a MAC address an IP address assigned to a network device identified by the MAC address; and
gateway address deducing means for deriving an IP address through the address deriving means for a MAC address paired with a plurality of IP addresses among a plurality of MAC addresses extracted by the extracting means, and deducing that the derived IP address is the IP address assigned to the gateway device.

8. The address deducing system as recited in claim 7, further comprising address list creating means for creating an address list for each different MAC address in which address list one or more IP addresses corresponding to the MAC address are entered and for recording IP addresses paired with the MAC address in the address list corresponding to the MAC address when a pair of a MAC address and IP address extracted by the extracting means has not been extracted in the past,
wherein the gateway address deducing means determines a MAC address with which a plurality of IP addresses is paired based on an address list created by the address list creating means, derives an IP address for the determined MAC address with the address list deriving means, and deduces that the derived IP address is the IP address assigned to the gateway device.

9. The address deducing system as recited in claim 7, further comprising subnet mask calculating means for identifying a MAC address paired with only a single IP address from among a plurality of MAC addresses extracted by the extracting means, and calculating a subnet mask based on the IP address paired with the identified MAC address and the IP address of the gateway device deduced by the gateway address deducing means.

10. The address deducing means as recited in claim 9, wherein the subnet mask calculating means uses a value A having the same number of bits as an IP address and an initial value of “1” for each bit, an IP address B for the gateway device deduced by the gateway address deducing means, and one or more IP addresses Cn paired with one or more MAC addresses identified a plurality of MAC addresses extracted by the extracting means to be paired with a single IP address: and executes a step 1 for calculating a value D by performing an exclusive OR operation on the IP address B and the IP addresses Cn, a step 2 for calculating a value E by performing a NOT operation on the value D calculated in step 1, a step 3 for calculating a value F by performing a logical AND operation on the value E calculated in step 2 and the value A, a step 4 for resetting the value A to the value F calculated in step 3, and a step 5 for repeating the steps 1 through 4 based on the number of IP addresses Cn; and setting the subnet mask to the final value of the value A set in step 4.

11. The address deducing system as recited in claim 7, further comprising subnet mask calculating means for calculating a subnet mask based on the highest-order byte in the IP address of the gateway device deduced by the gateway address deducing means.

12. The address deducing system as recited in claim 9, further comprising network address calculating means for calculating a network address based on the IP address of the gateway device deduced by the gateway address deducing means and the subnet mask calculated by the subnet mask calculating means.

13. A network device that requires as one of network settings at least an IP address of a gateway device that is one of a plurality of network devices on a network that performs communications between network devices using an Internet protocol and assigns different IP addresses to the plurality of network devices, each of the plurality of network devices having a personal MAC address, the network device comprising:
an address deducing system for deducing the IF address of the gateway device, the address deducing system comprising:
extracting means for extracting from data included in a packet transmitted over the network a destination MAC address and a destination IP address indicating the transmission destination of the packet;
address deriving means for deriving from a MAC address an IP address assigned to a network device identified by the MAC address; and
gateway address deducing means for deriving an IP address through the address deriving means for a MAC address paired with a plurality of IP addresses among a plurality of MAC addresses extracted by the extracting means, and deducing that the derived IP address is the IP address assigned to the gateway device; and
display means for displaying the IP address of the gateway device deduced by the gateway address deducing means.

14. The network device as recited in claim 13, wherein the address deducing system further comprises address list creating means for creating an address list for each different MAC address in which address list one or more IP addresses corresponding to the MAC address are entered and for recording IP addresses paired with the MAC address in the address list corresponding to the MAC address when a pair of a MAC address and IP address extracted by the extracting means has not been extracted in the past,
wherein the gateway address deducing means determines a MAC address with which a plurality of IP addresses is paired based on an address list created by the address list creating means, derives an IP address for the determined MAC address with the address list deriving means, and deduces that the derived IP address is the IP address assigned to the gateway device.

15. The network device as recited in claim 13, wherein the address deducing system further comprises subnet mask calculating means for identifying a MAC address paired with only a single IP address from among a plurality of MAC addresses extracted by the extracting means, and calculating a subnet mask based on the IP address paired with the identified MAC address and the IP address of the gateway device deduced by the gateway address deducing means.

16. The network device as recited in claim 15, wherein the subnet mask calculating means uses a value A having the same number of bits as an IP address and an initial value of “1” for each bit, an IP address B for the gateway device deduced by the gateway address deducing means, and one or more IP addresses Cn paired with one or more MAC addresses identified a plurality of MAC addresses extracted by the extracting means to be paired with a single IP address; and executes a step 1 for calculating a value D by performing an exclusive OR operation on the IP address B and the IP addresses Cn, a step 2 for calculating a value E by performing a NOT operation on the value D calculated in step 1, a step 3 for calculating a value F by performing a logical AND operation on the value E calculated in step 2 and the value A, a step 4 for resetting the value A to the value F calculated in step 3, and a step 5 for repeating the steps 1 through 4 based on the number of IF addresses Cn; and setting the subnet mask to the final value of the value A set in step 4.

17. The network device as recited in claim 13, wherein the address deducing system further comprises subnet mask calculating means for calculating a subnet mask based on the highest-order byte in the IP address of the gateway device deduced by the gateway address deducing means.

18. The network device as recited in claim 15, wherein the address deducing system further comprises network address calculating means for calculating a network address based on the IP address of the gateway device deduced by the gateway address deducing means and the subnet mask calculated by the subnet mask calculating means.

19. A network device that requires as one of network settings at least an IP address of a gateway device that is one of a plurality of network devices on a network that performs communications between network devices using an Internet protocol and assigns different IP addresses to the plurality of network devices, each of the plurality of network devices having a personal MAC address, the network device comprising:
an address deducing system for deducing an IP address assigned to the gateway device, the address deducing system comprising:
extracting means for extracting from data included in a packet transmitted over the network a source MAC address and a source IP address indicating the transmission source of the packet;
address deriving means for deriving from a MAC address an IP address assigned to a network device identified by the MAC address; and
gateway address deducing means for deriving an IP address through the address deriving means for a A&C address paired with a plurality of IP addresses among a plurality of MAC addresses extracted by the extracting means, and deducing that the derived IP address is the IP address assigned to the gateway device; and
display means for displaying the IP address of the gateway device deduced by the gateway address deducing means.

20. The network device as recited in claim 19, wherein the address deducing system further comprises address list creating means for creating an address list for each different MAC address in which address list one or more IP addresses corresponding to the MAC address are entered and for recording IP addresses paired with the MAC address in the address list corresponding to the MAC address when a pair of a MAC address and IP address extracted by the extracting means has not been extracted in the past,
wherein the gateway address deducing means determines a MAC address with which a plurality of IP addresses is paired based on an address list created by the address list creating means, derives an IP address for the determined MAC address with the address list deriving means, and deduces that the derived IP address is the IP address assigned to the gateway device.

21. The network device as recited in claim 19, wherein the address deducing system further comprises subnet mask calculating means for identifying a MAC address paired with only a single IP address from among a plurality of MAC addresses extracted by the extracting means, and calculating a subnet mask based on the IP address paired with the identified MAC address and the IP address of the gateway device deduced by the gateway address deducing means.

22. The network device as recited in claim 21, wherein the subnet mask calculating means uses a value A having the same number of bits as an IP address and an initial value of “1” for each bit, an IP address B for the gateway device deduced by the gateway address deducing means, and one or more IP addresses Cn paired with one or more MAC addresses identified a plurality of MAC addresses extracted by the extracting means to be paired with a single IP address; and executes a step 1 for calculating a value D by performing an exclusive OR operation on the IP address B and the IP addresses Cn, a step 2 for calculating a value E by performing a NOT operation on the value D calculated in step 1, a step 3 for calculating a value F by performing a logical AND operation on the value E calculated in step 2 and the value A, a step 4 for resetting the value A to the value F calculated in step 3, and a step 5 for repeating the steps 1 through 4 based on the number of IP addresses Cn; and setting the subnet mask to the final value of the value A set in step 4.

23. The network device as recited in claim 19, wherein the address deducing system further comprises subnet mask calculating means for calculating a subnet mask based on the highest-order byte in the IP address of the gateway device deduced by the gateway address deducing means.

24. The network device as recited in claim 21, wherein the address deducing system further comprises network address calculating means for calculating a network address based on the IP address of the gateway device deduced by the gateway address deducing means and the subnet mask calculated by the subnet mask calculating means.

25. A network device that requires as network settings at least the setting of a subnet mask for a network to which the network devices belongs and an IP address of a gateway device that is one of a plurality of network devices on the network that performs communications between network devices using an Internet protocol and assigns different IP addresses to the plurality of network devices, each of the plurality of network devices having a personal MAC address, the network device comprising:
an address deducing system for deducing the IP address of the gateway device, the address deducing system comprising:
extracting means for extracting from data included in a packet transmitted over the network a destination MAC address and a destination IP address indicating the transmission destination of the packet;
address deriving means for deriving from a MAC address an IP address assigned to a network device identified by the MAC address;
gateway address deducing means for deriving an IP address through the address deriving means for a MAC address paired with a plurality of IP addresses among a plurality of MAC addresses extracted by the extracting means, and deducing that the derived IP address is the IP address assigned to the gateway device; and
subnet mask calculating means for identifying a MAC address paired with only a single IP address from among a plurality of MAC addresses extracted by the extracting means, and calculating a subnet mask based on the IP address paired with the identified MAC address and the IP address of the gateway device deduced by the gateway address deducing means; and
display means for displaying the subnet mask calculated by the subnet mask calculating means.

26. The network device as recited in claim 25, wherein the subnet mask calculating means uses a value A having the same number of bits as an IP address and an initial value of “1” for each bit, an IP address B for the gateway device deduced by the gateway address deducing means, and one or more IP addresses Cn paired with one or more MAC addresses identified a plurality of MAC addresses extracted by the extracting means to be paired with a single IP address; and executes a step 1 for calculating a value D by performing an exclusive OR operation on the IP address B and the IP addresses Cn, a step 2 for calculating a value E by performing a NOT operation on the value D calculated in step 1, a step 3 for calculating a value F by performing a logical AND operation on the value E calculated in step 2 and the value A, a step 4 for resetting the value A to the value F calculated in step 3, and a step 5 for repeating the steps 1 through 4 based on the number of IP addresses Cn; and setting the subnet mask to the final value of the value A set in step 4.

27. The network device as recited in claim 25, wherein the subnet mask calculating means calculates the subnet mask based on the highest-order byte in the IP address of the gateway device deduced by the gateway address deducing means.

28. The network device as recited in claim 25, wherein the address deducing system further comprises network address calculating means for calculating a network address based on the IP address of the gateway device deduced by the gateway address deducing means and the subnet mask calculated by the subnet mask calculating means.

29. A network device that requires as network settings at least the setting of a subnet mask for a network to which the network device belongs and an IP address of a gateway device that is one of a plurality of network devices on the network that performs communications between network devices using an Internet protocol and assigns different IP addresses to the plurality of network devices, each of the plurality of network devices having a personal MAC address, the network device comprising:
an address deducing system for deducing the IP address assigned to the gateway device, the address deducing system comprising:
extracting means for extracting from data included in a packet transmitted over the network a source MAC address and a source IP address indicating the transmission source of the packet;
address deriving means for deriving from a MAC address an IP address assigned to a network device identified by the MAC address;
gateway address deducing means for deriving an IP address through the address deriving means for a MAC address paired with a plurality of IP addresses among a plurality of MAC addresses extracted by the extracting means, and deducing that the derived IP address is the IP address assigned to the gateway device; and
subnet mask calculating means for identifying a MAC address paired with only a single IP address from among a plurality of MAC addresses extracted by the extracting means, and calculating a subnet mask based on the IP address paired with the identified MAC address and the IP address of the gateway device deduced by the gateway address deducing means; and
display means for displaying the subnet mask calculated by the subnet mask calculating means.

30. The network device as recited in claim 29, wherein the subnet mask calculating means uses a value A having the same number of bits as an IP address and an initial value of “1” for each bit, an IP address B for the gateway device deduced by the gateway address deducing means, and one or more IP addresses Cn paired with one or more MAC addresses identified a plurality of MAC addresses extracted by the extracting means to be paired with a single IP address; and executes a step 1 for calculating a value D by performing an exclusive OR operation on the IP address B and the IP addresses Cn, a step 2 for calculating a value E by performing a NOT operation on the value D calculated in step 1, a step 3 for calculating a value F by performing a logical AND operation on the value E calculated in step 2 and the value A, a step 4 for resetting the value A to the value F calculated in step 3, and a step 5 for repeating the steps 1 through 4 based on the number of IP addresses Cn; and setting the subnet mask to the final value of the value A set in step 4.

31. The network device as recited in claim 29, wherein the subnet mask calculating means calculates the subnet mask based on the highest-order byte in the IP address of the gateway device deduced by the gateway address deducing means.

32. The network device as recited in claim 29, wherein the address deducing system further comprises network address calculating means for calculating a network address based on the IP address of the gateway device deduced by the gateway address deducing means and the subnet mask calculated by the subnet mask calculating means.

33. A network device having the address deducing system of claim 6 and requiring as one of network settings at least the setting of the IP address assigned to the network device itself, the network device comprising display means for displaying the network address calculated by the network address calculating means.

34. A network device having the address deducing system of claim 11 and requiring as one of network settings at least the setting of the IP address assigned to the network device itself, the network device comprising display means for displaying the network address calculated by the network address calculating means.

35. A network device having the address deducing system of claim 6 and requiring as one of network settings at least the setting of the IP address assigned to the network device itself, the network device comprising display means for displaying data based on an IP address of a network device from among IP addresses extracted by the extracting means, the network device belonging to a network indicated by a network address calculated by the network address calculating means.

36. A network device having the address deducing system of claim 11 and requiring as one of network settings at least the setting of the IP address assigned to the network device itself, the network device comprising display means for displaying data based on an IP address of a network device from among IP addresses extracted by the extracting means, the network device belonging to a network indicated by a network address calculated by the network address calculating means.

37. An address deducing method for deducing an IP address assigned to a gateway device that is one of a plurality of network devices on a network that performs communications between network devices using an Internet protocol and assigns different IP addresses to the plurality of network devices, each of the plurality of network devices having a personal MAC address, the address deducing method comprising the steps of:
(a) extracting from data included in a packet transmitted over the network a destination MAC address and a destination IP address indicating the transmission destination of the packet;
(b) deriving from a MAC address an IP address assigned to a network device identified by the MAC address; and
(c) deriving an IP address for a MAC address paired with a plurality of IP addresses among a plurality of MAC addresses extracted in step (a), and deducing that the derived IP address is the IP address assigned to the gateway device.

38. An address deducing method for deducing an IP address assigned to a gateway device that is one of a plurality of network devices on a network that performs communications between network devices using an Internet protocol and assigns different IP addresses to the plurality of network devices, each of the plurality of network devices having a personal MAC address, the address deducing method comprising the steps of:
(a) extracting from data included in a packet transmitted over the network a source MAC address and a source IP address indicating the transmission source of the packet;
(b) deriving from a MAC address an IP address assigned to a network device identified by the MAC address; and
(c) deriving an IP address for a MAC address paired with a plurality of IP addresses among a plurality of MAC addresses extracted in step (a), and deducing that the derived IP address is the IP address assigned to the gateway device.

39. An address deducing program for deducing an IP address assigned to a gateway device that is one of a plurality of network devices on a network that performs communications between network devices using an Internet protocol and assigns different IP addresses to the plurality of network devices, each of the plurality of network devices having a personal MAC address. the address deducing program comprising:
a program of extracting from data included in a packet transmitted over the network a destination MAC address and a destination IP address indicating the transmission destination of the packet;
a program of deriving from a MAC address an IP address assigned to a network device identified by the MAC address; and
a program of deriving an IP address for a MAC address paired with a plurality of IP addresses among a plurality of MAC addresses extracted in step (a), and deducing that the derived IP address is the IP address assigned to the gateway device.

40. An address deducing program for deducing an IP address assigned to a gateway device that is one of a plurality of network devices on a network that performs communications between network devices using an Internet protocol and assigns different IP addresses to the plurality of network devices, each of the plurality of network devices having a personal MAC address, the address deducing program comprising:
a program of extracting from data included in a packet transmitted over the network a source MAC address and a source IP address indicating the transmission source of the packet;
a program of deriving from a MAC address an IP address assigned to a network device identified by the MAC address; and
a program of deriving an IP address for a MAC address paired with a plurality of IP addresses among a plurality of MAC addresses extracted in step (a), and deducing that the derived IP address is the IP address assigned to the gateway device.
